(19) United States
(12) Patent Application Publication
(10) Pub. No.: US 2003/0209476 A1
(43) Pub. Date: Nov. 13, 2003

(54) Biological fluidized bed apparatus

(76) Inventors: Juan Carlos Josse, Capistrano Beach, CA (US); John William Sutherlin, New Orleans, LA (US)

Correspondence Address: Mark A. Taylor, Stoll, Keenon & Park, LLP, Suite 2100, 300 W. Vine Street, Lexington, KY, 40507-1801, US

(21) Appl. No.: 10/125,282

(22) Filed: Apr. 18, 2002

Related U.S. Application Data
(63) Continuation-in-part of application No. 09/839,653, filed on May 13, 2002, now Pat. No. 6,531,058.

(51) Int. Cl. B01D 33/70

(52) U.S. Cl. 210/151

(57) ABSTRACT

A biological fluidized bed apparatus for the treatment of wastewater comprises: a reactor tank having a conical bottom with angles ranging from about 30 to about 80 degrees, and most preferably about 60 degrees from a horizontal plane; an inert media bed within said tank; and a recirculation pipe within said tank having an upper inlet, and a lower conformed outlet fitting within said media. The apparatus is self-contained, and offers easy and uniform expansion for various types of commercially available media. Besides the biological treatment accomplished within the fluidized bed, this reactor provides mechanical solids/gas/liquid separation and upflow sludge blanket clarification to improve effluent quality. Preferred additional features of the apparatus include a rotating surface skimmer and an excess sludge collection and thickening device powered by an externally mounted drive. With this reactor configuration, anaerobic and anoxic biological treatment and subsequent clarification are achieved in a single enclosed tank.

### CROSS-REFERENCE TO RELATED APPLICATION

The present application is a continuation-in-part of U.S. patent application Ser. No. 09/839,653, filed Nov. 7, 2000.

### BACKGROUND OF THE INVENTION

The present invention is directed to a biological fluidized bed apparatus to treat wastewater. More particularly, the invention relates to the a fluidized bed apparatus having a frusto-conical bottom tank portion, a solids collection trough and a solids/gas/liquids separator assembly.

Over the last twenty years, extensive research has been done in the US, Europe and Japan to develop various fluidized bed reactor configurations and processes. Patented contributions in this field are disclosed in U.S. Pat. Nos. 4,482,458 (Rovel, et al.); 4,940,546 (Vogelpohl, et al.); 5,441,634 (Edwards); 4,530,762 (Love); 4,762,612 (Yoda, et al.); 5,573,671 (Klein); 5,942,116 (Clark, et al.).

Biological fluidized bed reactors have been widely used to remove dissolved and suspended organic matter from high-strength industrial effluents. In this application, the biological beds are comprised of anaerobic bacteria. Anoxic fluidized bed reactors have also been used for the removal of nitrate from industrial and municipal effluents, in which case the biological bed is comprised of denitrifying bacteria.

In the anaerobic application, these reactors convert dissolved and suspended organic matter into methane and carbon dioxide (biogas). The conversion is accomplished by anaerobic bacteria, which grow attached as biofilm to inert media particles in the fluidized bed. The reduction of organic matter in the treated waste is the result of a combination of physical retention of suspended and colloidal organic matter by solids contact flocculation within the biological bed, hydrolysis of the trapped solids by hydrolyzing bacteria present in the anaerobic consortium, and finally biological conversion of dissolved organic matter into biogas by acidogenic and then methanogenic bacteria.

In the anoxic application, these reactors convert nitrate into nitrogen gas. The conversion of nitrate to nitrogen gas is accomplished by denitrifying bacteria that grow attached to inert media particles in the fluidized bed. These heterotrophic bacteria are ubiquitous in most natural waters. In the process of denitrification, nitrate acts as an electron acceptor and an organic substrate as a reduced electron donor. The substrate used as an electron donor and a source of carbon is a readily degradable organic substrate (i.e., methanol, sugars or acetic acid), which is supplemented to the anoxic reactor.

The fluidized bed reactors in use employ an attached biofilm fluidized bed process that is based on the concept that large biomass concentrations can be achieved on a large surface area by dense biofilm attachment to an inert small particle size carrier. A large surface area is created by small inert particles in a bed, fluidized by upward flow. The intense mixing occurring in the bed minimizes diffusion limitations and eliminates clogging and short-circuiting problems. These reactors accumulate large amounts of active biomass, and can achieve very long cell detention times.

Existing fluidized bed reactors typically consist of a cylindrical column with flat bottom. These columns contain a bed of small inert particles, 0.4-1.0 mm zeolite, diatomaceous earth, or activated carbon particles. The bed is fluidized by the upward flow through the column of untreated wastewater mixed with recirculated effluent. In existing reactors, the upward flow necessary to achieve bed fluidization is distributed by means of various nozzles or small diameter pipes placed at the bottom of the column. Anaerobic biofilm develops on the inert media and the physical attachment of anaerobic bacteria to the media surface prevents biomass washout. The high fluid shear force resistance of biofilms allows these reactors to be operated at upflow velocities which would otherwise wash out unattached biomass.

Upflow velocities are set by the recirculation flow, according to the fluidization properties of the bio-particles (e.g., inert particles with attached bacterial film). The upflow velocities are sufficient to reach bed expansions as to allow free release of generated gas bubbles. The degree of bed expansion is achieved by controlling the recirculation flow rate of a portion of the effluent in a closed loop.

Under some conditions the turbulent flow exerts sufficient shear to prevent the development of thick biofilms on the media, which limit mass transfer. The high surface-to-volume ratio of the bulk of the bed inert media (approximately 300 to 2500 ft²/ft³) creates a vast area for the development of microbial biofilm. Approximately 95 percent of the active biomass in a well-operated fluidized bed reactor is attached growth. This fact enables the development of dense but thin biofilms that lead to high concentrations of attached biomass in the bed.

Despite the great advantages that this process offers in terms of high organic loading rates, short hydraulic retention times and low excess solids generation, the use of these reactors has not been extensive due to various design limitations. The most common problems reported in full-scale applications and their effects on operation and effluent quality are:

(a) Inadequate Flow Distribution At The Bottom Of The Bed

In current fluidized bed reactor configurations, clogging of distribution nozzles and the existence of “dead zones,” channeling and short-circuiting inside the bed are major disadvantages. Good flow distribution is necessary to achieve uniform and controlled bed expansion and a well-mixed flow pattern inside the bed. Such patterns promote turbulence at the biofilm/liquid interface and enable all the attached biomass to be in contact with the waste.

When a uniform expansion of the bed is obtained, biogas bubbles generated in the bed are evenly released. This avoids the coalescence of small bubbles into much larger bubbles that disrupt the bed as they rise. Such bed disruptions deteriorate the quality of the effluent by releasing solids trapped within the bed.

Although the solution to inadequate bed expansion would appear to be increasing the recirculation flow in order to achieve higher upflow velocity, this presents the disadvantage of washing solids trapped in the bed, by the high interstitial velocities created by the increased flow. These solids deteriorate the quality of the effluent.

(b) Need For Highly Uniform Particle Size Media In Cylindrical Reactor Configurations

In cylindrical, flat bottom reactors, the inert media must have a highly uniform particle size. Typical media materials are zeolite, sand, and activated carbon. Commercially available media are not highly uniform in particle size. A more uniform particle size media has a higher cost, since narrow particle size range sieving produces more wasted material for the media manufacturer.

Since the upflow velocity in cylindrical reactors is constant throughout the bed, the existence of various particle sizes affects uniform expansion. Larger particles weigh more and have higher terminal settling velocities. Thus, higher upflow velocities are required to keep them suspended. If there is a range in the particle size of the media, at the upflow velocity necessary to expand the large particles the small particles are carried out of the bed, or are over-expanded. On the other hand, at an upflow velocity at which small media particles reach adequate fluidization, large particles remain unexpanded at the bottom of the reactor, creating a plug and hindering uniform expansion.

(c) Inadequate Solids/Gas/Liquid Separation Within The Reactor

Before the treated effluent exits the top of the reactor, suspended solids need to be removed. The rising bubbles above the bed create a drag effect that helps carry suspended solids to the top of the reactor. Gas bubbles also tend to trap suspended solids, which are attracted by the surface tension of the bubbles. In several reactors without an appropriate incorporated solids separation system, organic loadings are kept below the reactor's capacity in order to reduce gas generation as a measure to limit suspended solids concentrations in the effluent. In several reactor configurations, additional equipment is used to polish the effluent. Such equipment can include external clarifiers.

Many industrial and farm wastes produce a scum layer at the water surface inside the reactor. This layer of floating grease and organic material needs to be removed so that it does not accumulate or appear in the effluent. There exists a need for a surface skimmer and an effluent launderer to achieve this objective.

(d) Difficulty In Removing Excess Solids From The Reactor

Anaerobic bacteria are slow growers, however as a result of substrate consumption there is biomass growth. Thus, there is a need to accumulate and store detached biomass inside the reactor and to remove it for disposal. It is important to provide sufficient solids retention time inside anaerobic reactors, in order to achieve adequate digestion of the excess solids produced. This eliminates the need for further sludge stabilization outside the reactor. However, failure to accumulate and remove excess biomass without disturbing the operation of the reactor, will affect the performance of the unit and the quality of the effluent.

### SUMMARY OF THE INVENTION

The biological fluidized bed apparatus according to the present invention provides a modular, self-contained biological reactor, which can treat municipal, industrial and confined animal feedlot wastewater at high loading rates. This reactor design overcomes the limitations and disadvantages of prior fluidized bed reactor configurations by means of its shape and internal components. As a result, it provides better quality effluent, requires less “foot print” area for installation and demands less maintenance.

The apparatus overcomes several disadvantages of current fluidized bed reactor configurations. Several improvements are achieved by the present invention. It should be noted that reference herein to specific construction materials, dimensions and the like are suggestive of how to practice the invention, but should not be construed to limit the invention in any way.

The present invention provides a more uniform flow distribution at the bottom of the bed. This is achieved using a reactor tank with a frusto-conical bottom about 30 to about 80 degrees from the horizontal (inverted truncated cone), and a single internal vertically oriented, down-coming drop pipe discharging recirculated flow at the bottom of the cone. Preferably, the conical bottom has an angle in the range from about 45 to about 75 degrees, more preferably from about 55 to about 72 degrees, and particularly preferably from about 57 to about 70 degrees. The most preferable angle is about 60 degrees.

In order to limit turbulence at the bottom of the reactor, the flow exits the pipe radially by means of a conformed outlet defining a flow distribution fitting. The flow distribution fitting is preferably molded. This fitting, which changes the direction of the flow approximately 90 degrees from vertical to radial, is contoured internally to reduce friction losses and smoothen the change of direction of the flow lines. The open area of the flow distribution fitting is such that exit velocities are sufficiently high to drag the larger bioparticles located at the bottom of the reactor. The required drag velocity is achieved at a flow sufficient to create the upflow velocity required for the minimum admissible bed expansion. The flow distribution design eliminates nozzle clogging, since a single fitting is used instead of a network of multiple small diameter nozzles. With this design, no channeling or “dead zones” form in the bed. Additionally, bed expansion is uniform and can be controlled very precisely by adjusting the recirculation flow. A more uniform fluidization enables gas bubbles to be released evenly throughout the section of the bed.

Media with a lower particle size uniformity coefficient can be efficiently fluidized. The conical bottom reactor design allows a wider range of particle sizes in the media to be fluidized, as a result of the various upflow velocities occurring through the conical portion of the reactor. At a constant recirculation flow, upflow velocities gradually decrease from the bottom of the inverted cone through the cylindrical portion of the tank. This is a result of the change in sectional area of the conical portion. Having various upflow velocities in the lower section of the reactor accommodates the use of media with a wider range of particle sizes. Larger, heavier particles will concentrate towards the bottom of the cone, where higher upflow velocities occur due to reduced cross-sectional area. Accordingly, smaller, lighter particles will accumulate in the upper section of the cone, which has lower upflow velocities. This feature enables the use of biofilm support media with less uniform particle size. This reduces the cost of the media since it can be purchased as a readily available commercial product.

Solids carry-over with the reactor effluent can be greatly minimized. The apparatus configuration preferably includes an internal downflow solids/gas/liquid separator at the top of the unit. Solids are normally carried out of the bed along with small nitrogen or biogas bubbles resulting from methanogenic or denitrification bacterial activity, depending on the application. A gradual reduction of the sectional area of the flow path in the upper section of the reactor forces gas bubbles to coalesce into larger bubbles. These bubbles exit the liquid at higher velocity leaving attached solids in the liquid stream. Liquid is forced to flow downward at high velocity along the sloped wall of the separator, into a submerged trough. The upflow velocity above the trough is extremely low, such that the solids are not picked up from the trough. A slow-rotating paddle sweeps the trough and pushes most of the solids into one or more, for example two, collection boxes connected to the intake of the recirculation pump. This way, most of the solids retained in the separator are forced to re-enter the bed. A portion of the separated solids is pushed into one or more, preferably two, other deeper collection boxes for accumulation, thickening and periodic wasting. Thickened solids sludge is removed from these boxes, preferably by means of electrically actuated valves operating on timers.

Additionally, the reactor preferably includes a quiescent clarification zone, external to the separator. Gas bubbles are isolated from the clarification zone and do not interfere with this process. The clarification zone has a gradual increase in cross-sectional area. Thus, it operates as an upflow solids contact clarifier. On top of the clarification zone, an effluent trough disposed on the perimeter of the reactor collects the effluent overflow. An effluent launderer, installed along the trough, retains floating solids. A slow-rotating skimmer arm connected to the same sweeping mechanism of the submerged trough, pushes scum and floating solids on the surface of the water into a scum box. Scum and floatables collected in this box are removed by means of an electrically actuated valve. A submerged solids overflow port allows for periodic sludge blanket wastage. This internal solids/gas/liquid separator provides a reliable means for separation of the three phases. The separator provides an enclosed volume above the surface of the water for the accumulation and removal of biogas.

### BRIEF DESCRIPTION OF THE DRAWINGS

FIG. 1 is a general orientation showing shape and cutting planes for sectional views, wherein the figure shows top and side views of the biological fluidized bed apparatus with main ports;

FIG. 2 is a sectional view taken along line A-A of the biological fluidized bed apparatus illustrated in FIG. 1, including its stand, ladder, safety railing and external drive for the solids collection paddle and surface skimmer arm, wherein the overall suggested external dimensions of the reactor are presented;

FIG. 3 is a sectional view taken along line B-B of the biological fluidized bed apparatus illustrated in FIG. 1, wherein details of the return solids and waste solids collection boxes, as well as the incoming line part of the recirculation and feed system, are shown;

FIG. 4 is another sectional view taken along line A-A of the biological fluidized bed apparatus illustrated in FIG. 1, and labels most components;

FIG. 5 is a sectional view taken along line A-A of the biological fluidized bed apparatus of FIG. 1 with a schematic representation of direction of the flow through the fluidized bed and through the solids/gas/liquid separator, wherein the operation of the unit is shown;

FIGS. 6 and 7 are elevational views showing detailed suggested dimensions of the solids trough and lower portion of the solid/gas/liquid separator, and the lower body of the biological fluidized bed apparatus;

FIGS. 8-10 are elevational views showing the upper body of the apparatus, as well as the upper component of the solid/gas/liquid separator and effluent trough;

FIG. 11 is a sectional view of a molded flow distribution fitting according to one aspect of the present invention; and

FIG. 12 is an isometric sketch of an installed biological fluidized bed apparatus, wherein basic piping, recirculation pump, and wastewater feed connections are depicted in schematic form.

### DESCRIPTION OF THE PREFERRED EMBODIMENT

### Parts List

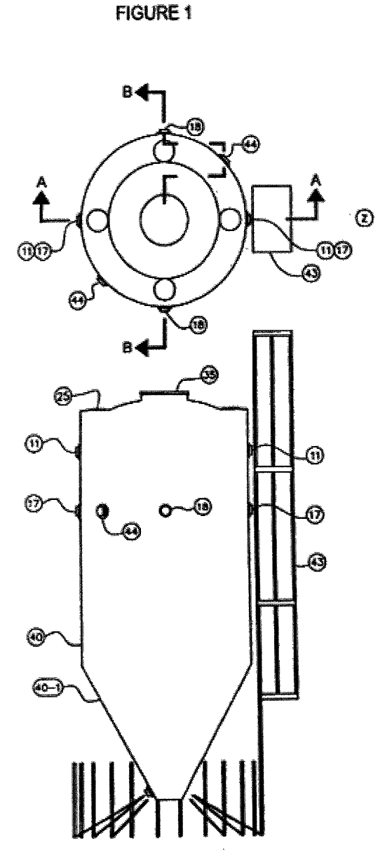

In FIGS. 1 to 12, the reference numerals and letters represent features or suggested dimensions as follows:

FIG. 1

Cutting Planes And Orientation

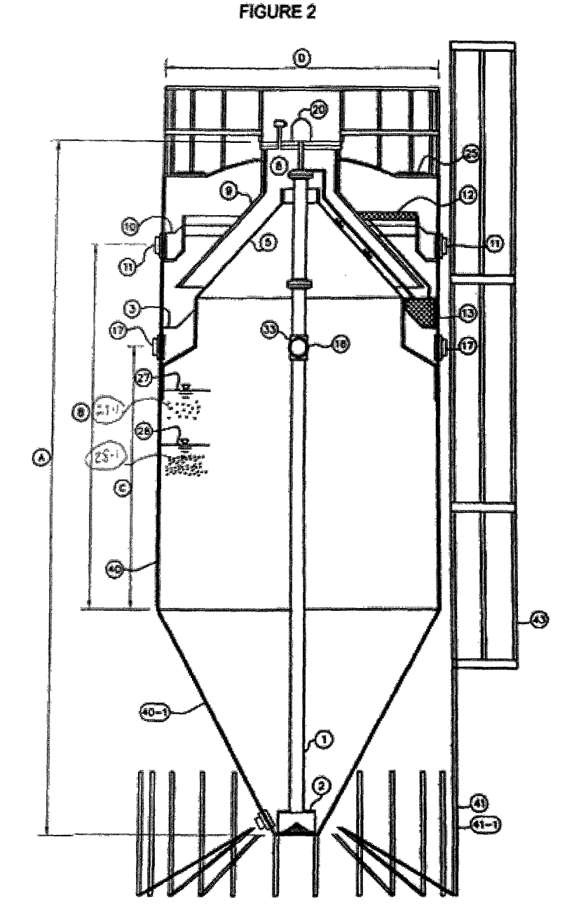

A-A Cutting plane used for sections in FIGS. 2, 4, and 5

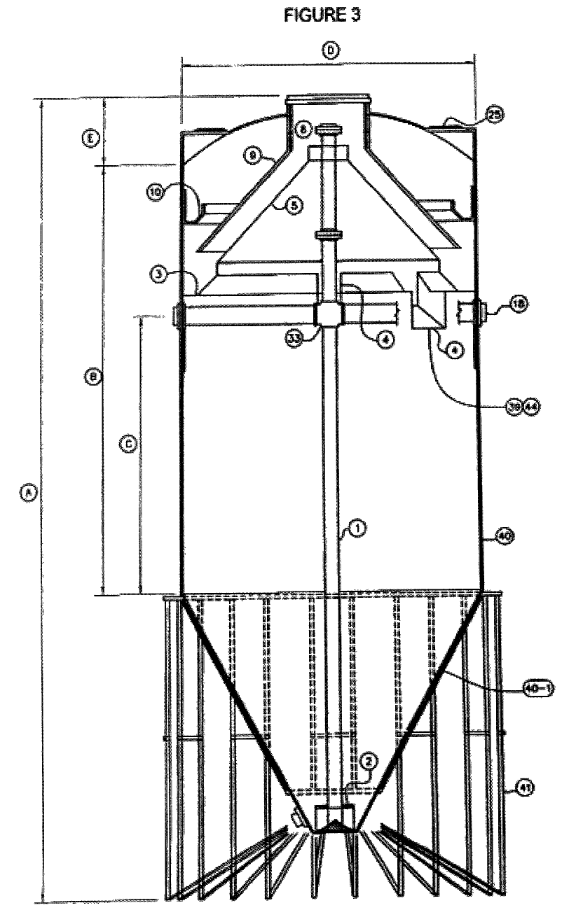

B-B Cutting plane used for sections in FIG. 3

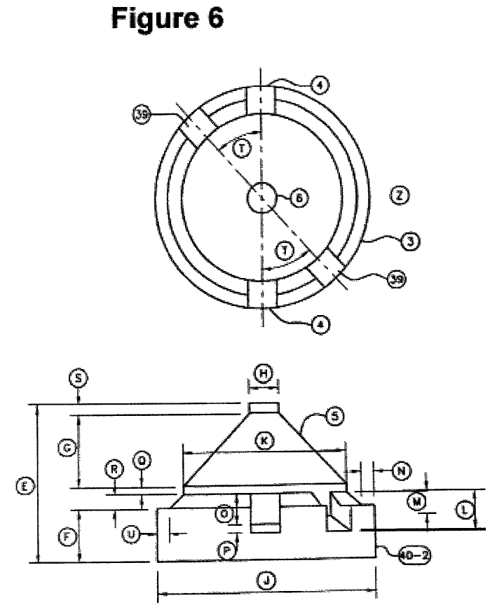

Z Orientation point for proper placement of component 6 in FIG. 6

Components

11 Effluent line connection (bulkhead fitting). Appears at two locations.

17 Recirculation line suction connection. Bulkhead fitting connects to suction of recirculation pump. Appears at two locations.

18 Recirculation line discharge connection. Bulkhead fitting connects to discharge of recirculation pump. Appears at two locations.

25 Access covers for reactor surface and effluent trough clean out. Access covers to upper portion of reactor. Appears at four locations.

35 Removable cover

40 Reactor tank, cylindrical middle portion

40-1 Reactor tank, conical bottom portion

43 Safety ladder

44 Excess solids wastage port (bulkhead fitting). Appears at two locations.

FIG. 2

Suggested Dimensions

A 7848 mm

B 4166 mm

C 2997 mm

D 3556 mm

Components

1 Recirculation and feed flow discharge pipe

2 Flow distribution molded fitting

3 Carry-over solids collection trough

5 Gas deflector, part of solids/gas/liquid separator

8 Gas storage chest

9 Recirculation flow deflector, part of solids/gas/liquid separator

10 Effluent trough

11 Effluent line connection (bulkhead fitting). Two locations

12 Surface skimmer arm

13 Solids collection paddle. Sweeps at low speed the solids collection trough

17 Recirculation line suction connection. Bulkhead fitting connects to suction of recirculation pump. Appears at two locations.

18 Recirculation line discharge connection. Bulkhead fitting connects to discharge of recirculation pump. Appears at two locations.

20 Motor-reducer unit to power solids paddle and surface skimmer

25 Access covers for reactor surface and effluent trough clean out. Access covers to upper portion of reactor Appears at four locations.

27 Fluidized bed level. Media expands to this level when recirculation system is in operation

28 Settled media level. Media level without recirculation flow

33 PVC cross fitting with reducers. Part of flow recirculation system

40 Reactor tank, cylindrical middle portion

40-1 Reactor tank, conical bottom portion

41 Reactor tank metal base

41-1 Metal base shown partially for clarity of reactor details

43 Safety ladder

FIG. 3

Suggested Dimensions

A 8788 mm

B 4725 mm

C 2997 mm

D 3556 mm

E 686 mm

Components

1 Recirculation and feed flow discharge pipe

2 Flow distribution molded fitting

3 Carry-over solids collection trough

4 Return solids accumulation box. Appears at two locations.

5 Gas deflector, part of solids/gas/liquid separator

8 Gas storage chest

9 Recirculation flow deflector, part of solids/gas/liquid separator

10 Effluent trough

18 Recirculation line discharge connection. Bulkhead fitting connects to discharge of recirculation pump. Appears at two locations.

25 Access covers for reactor surface and effluent trough clean out. Access covers to upper portion of reactor. Appears at four locations.

39 Wastage solids accumulation and thickening box

40 Reactor tank, cylindrical middle portion

40-1 Reactor tank, conical bottom portion

41 Reactor tank metal base

42 Excess solids wastage port, bulkhead fitting in box 39 not shown. Appears at two locations.

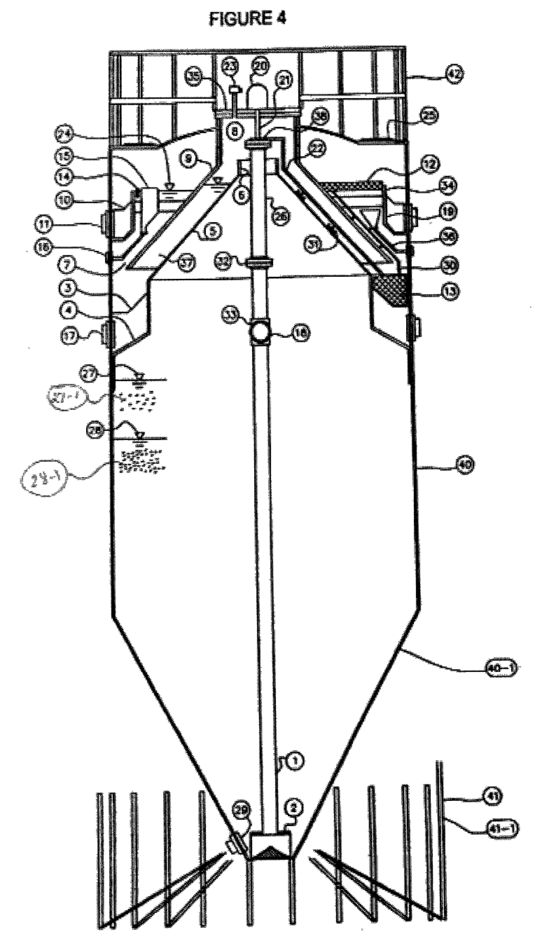

FIG. 4

Components

1 Recirculation and feed flow discharge pipe

2 Flow distribution molded fitting

3 Carry-over solids collection trough

4 Return solids accumulation box. Appears at two locations.

5 Gas deflector, part of solids/gas/liquid separator

6 Gas bubble-coalescence collar, part of solids/gas/liquid separator

7 Upflow clarification quiescent zone (sludge blanket to form in this section)

8 Gas storage chest

9 Recirculation flow deflector, part of solids/gas/liquid separator

10 Effluent trough

11 Effluent line connection (bulkhead fitting). Appears at two locations.

12 Surface skimmer arm

13 Solids collection paddle. Sweeps at low speed the solids collection trough

14 Effluent launderer. Placed around effluent overflow weir

15 Scum and floatables collection box. One location

16 Scum and floatables wastage pipe connection (bulkhead fitting). Appears at one location.

17 Recirculation line suction connection. Bulkhead fitting connects to suction of recirculation pump. Appears at two locations.

18 Recirculation line discharge connection. Bulkhead fitting connects to discharge of recirculation pump. Appears at two locations.

19 Effluent trough box. Accommodates effluent bulkhead fitting. Appears at two locations.

20 Motor-reducer unit to power solids paddle and surface skimmer

21 Power transmission mechanism. Splined shaft

22 Rotating arm connecting splined shaft to solids collection paddle

23 Gas release valve

24 Water level inside reactor

25 Access covers for reactor surface and effluent trough clean out. Access covers to upper portion of reactor. Appears at four locations.

26 Support pipe for rotating mechanism of solids paddle and surface skimmer

27 Fluidized bed level. Media expands to this level when recirculation system is in operation

27-1 Expanded media bed

28 Settled media level. Media level without recirculation flow

28-1 Settled media bed

29 Bulkhead fitting for media removal and emergency fluidization with booster pump when bed becomes compacted

30 Arm driving surface skimmer. Connected to arm 22

31 Plastic rollers to support load of rotating arms. Rollers move in contact with upper surface of part 5

32 Blind flange and PVC reducer. Supports base pipe 26

33 PVC cross fitting with reducers. Part of flow recirculation system

34 Effluent overflow weir

35 Removable cover

36 Internal weir for sludge blanket level control. Connection pipe and bulkhead fitting. Appears at one location.

37 Down-flow passage of separator

38 Rotating hub with axial bearing. Driven by shaft 21

40 Reactor tank, cylindrical middle portion

40-1 Reactor tank, conical bottom portion

41 Reactor tank metal base

41-1 Metal base shown partially for clarity of reactor details

42 Safety railing

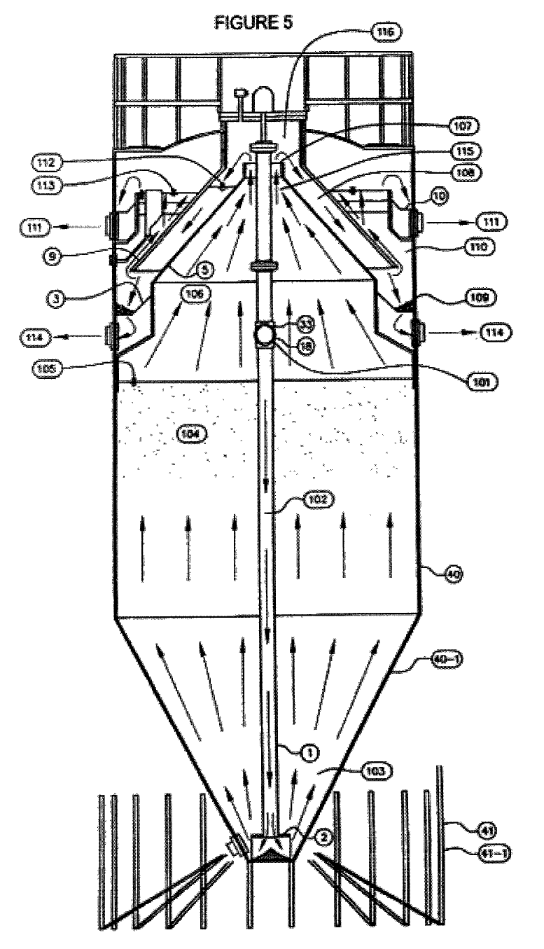

FIG. 5

Components

1 Recirculation and feed flow discharge pipe

2 Flow distribution molded fitting

3 Carry-over solids collection trough

5 Gas deflector, part of solids/gas/liquid separator

9 Recirculation flow deflector, part of solids/gas/liquid separator

10 Effluent trough

18 Recirculation line discharge connection. Bulkhead fitting connects to discharge of recirculation pump. Appears at two locations.

33 PVC cross fitting with reducers. Part of flow recirculation system

40 Reactor tank, cylindrical middle portion

40-1 Reactor tank, conical bottom portion

41 Reactor tank metal base

41-1 Metal base shown partially for clarity of reactor details

Description Of Operation

101 Recirculation and raw waste into reactor

102 Recirculation and raw waste flow into bottom of reactor

103 High velocity area for fluidization of larger media particles

104 Low velocity area for fluidization of finer media particles.

105 Fluidized bed level. Bed-liquid interface

106 Water, gas and suspended solids

107 Treated water overflow into solids separation zone

108 Downward flow deflector zone. Treated water with suspended solids flow into solids collection trough forced by suction of recirculation pump

109 Separated solids accumulate in trough. Solids collection paddle sweeps trough at low speed pushing solids into recirculation and wastage boxes.

110 Quiescent solids contact clarification zone. Solids separation by means of sludge blanket formed in this area

111 Treated effluent discharge port

112 Water level in solids separator

113 Water level in reactor dictated by height of effluent overflow weir

114 Recirculation port out of reactor. Bulkhead fitting connects to suction of recirculation pump. Treated water prior to solids separation exits reactor along with suspended solids and reenters at the bottom of the bed.

115 Contraction to enable coalescence of fine gas bubbles to enhance gas/liquid separation.

116 Gas storage volume. Gas is removed through valve 23.

FIG. 6

Cutting Planes And Orientation

Z Point of orientation for figure

Suggested Dimensions

E 2260 mm

F 686 mm

G 1092 mm

H 508 mm

J 3505 mm

K 2743 mm

L 660 mm

M 432 mm

N 178 mm

O 559 mm

P 102 mm

Q 127 mm

R 229 mm

S 152 mm

T 43 degree offset angle between centerlines of recirculation and solids wastage boxes.

U 178 mm

Components

3 Carry-over solids collection trough

4 Return solids accumulation box. Appears at two locations.

5 Gas deflector, part of solids/gas/liquid separator

6 Gas bubble-coalescence collar, part of solids/gas/liquid separator

39 Wastage solids accumulation and thickening box

40-2 Portion of cylindrical section of reactor tank to join with lip of the cylindrical middle portion of the reactor tank 40

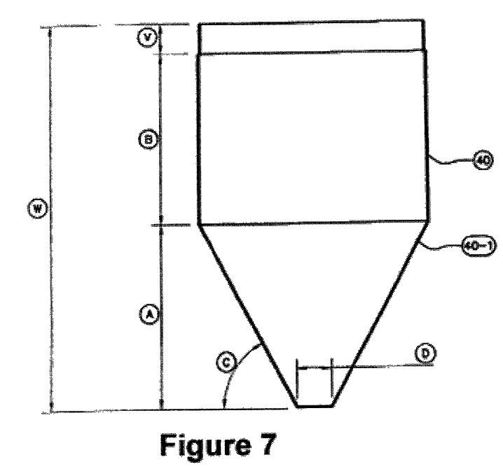

FIG. 7

Suggested Dimensions

A 2692 mm

B 2413 mm

C Angle ranging from about 30 to about 80 degrees, most preferably from about 57 to about 70 degrees

D 432 mm

V 152 mm

W 5258 mm

Components

40 Reactor tank, cylindrical middle portion

40-1 Reactor tank, conical bottom portion

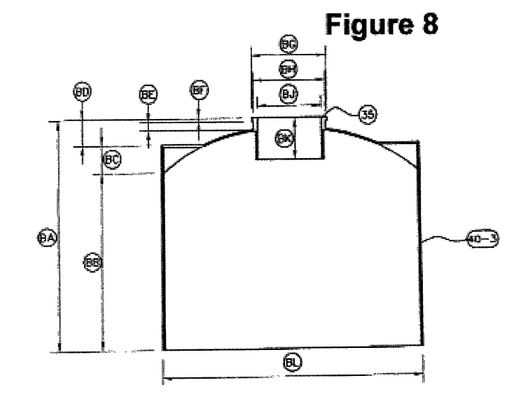

FIG. 8

Suggested Dimensions

BA 2870 mm

BB 2286 mm

BC 254 mm

BD 330 mm

BE 127 mm

BF 25 mm

BG 1194 mm

BH 1041 mm

BJ 914 mm

BK 457 mm

BL 3556 mm

Components

35 Removable cover

40-3 Upper cylindrical portion of reactor tank

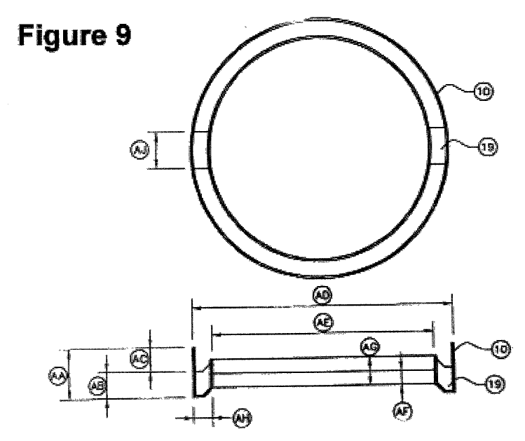

FIG. 9

Suggested Dimensions

AA 660 mm

AB 330 mm

AC 330 mm

AD 3505 mm

AE 2997 mm

AG 254 mm

AF 127 mm

AJ 508 mm

Components

10 Effluent trough

19 Effluent trough box. Accommodates effluent bulkhead fitting. Appears at two locations.

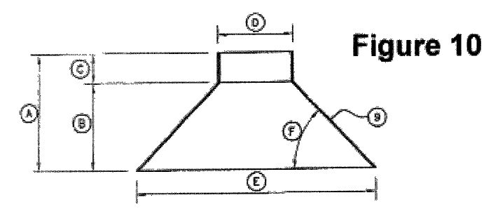

FIG. 10

Suggested Dimensions

A 1346 mm

B 1067 mm

C 279 mm

D 965 mm

E 3100 mm

F 45 degree angle

Components

9 Recirculation flow deflector, part of solids/gas/liquid separator

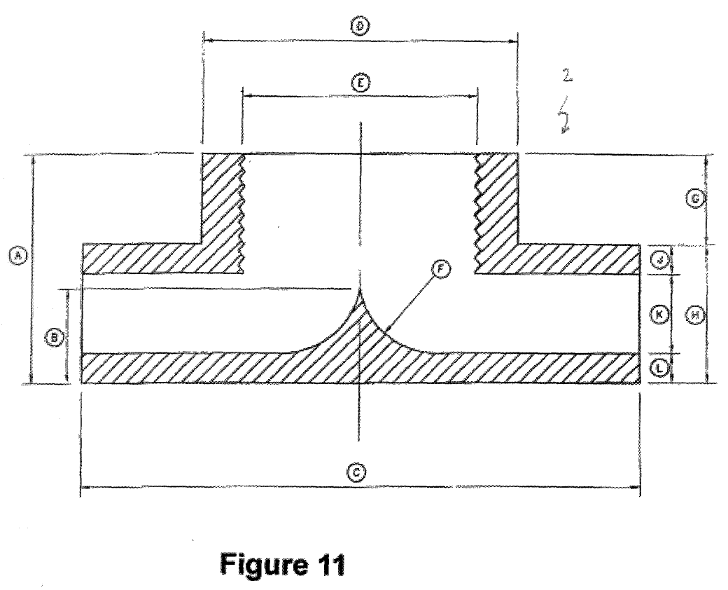

FIG. 11.

Suggested Dimensions

A 146 mm

B 60 mm

C 356 mm

D 203 mm

E 150 mm pipe thread

F Radius of 50 mm

G 57 mm

H 89 mm

J 19 mm

K 51 mm

L 19 mm

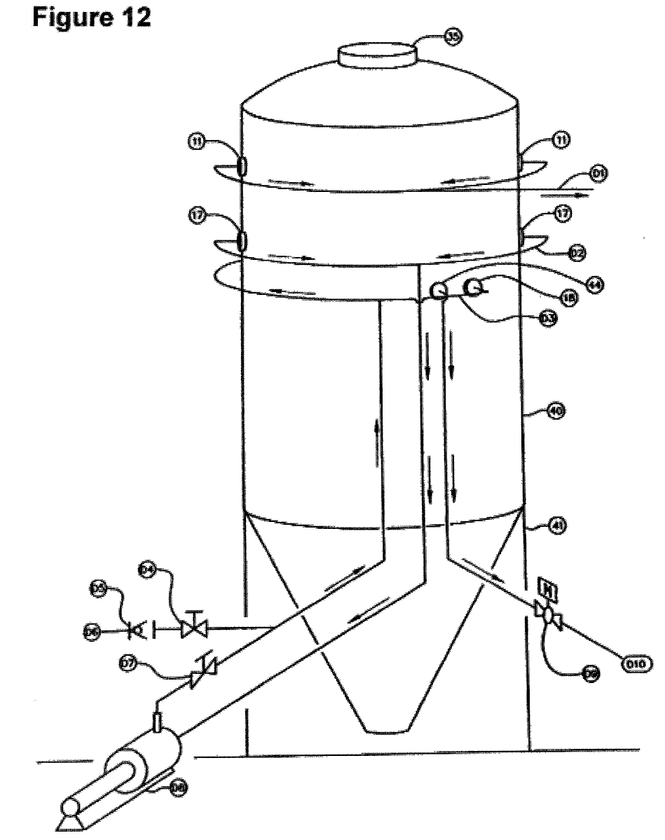

FIG. 12

External Components

D1 Treated effluent discharge line

D2 Recirculation water out of reactor to suction of recirculation pump

D3 Recirculation water into reactor, discharged by recirculation pump

D4 Wastewater feed isolating valve

D5 Wastewater feed check valve

D6 Wastewater feed

D7 Recirculation flow control valve

D8 Recirculation pump

D9 Solids wastage motorized valve operated on timer

D10 Wasted solids storage and processing

Components

11 Effluent line connection (bulkhead fitting). Appears at two locations.

17 Recirculation line suction connection. Bulkhead fitting connects to suction of recirculation pump. Appears at two locations.

18 Recirculation line discharge connection. Bulkhead fitting connects to discharge of recirculation pump. Appears at two locations.

35 Removable cover

40 Reactor tank, cylindrical middle portion

41 Reactor tank metal base

44 Excess solids wastage port. Bulkhead fitting placed in box 39. Appears at two locations.

### DETAILED DESCRIPTION

The biological fluidized bed apparatus depicted in the figures is a modular, prefabricated reactor. The suggested dimensions shown in FIG. 2 correspond to substantially the largest unit, for example, that can be pre-fabricated and transported from the manufacturing facility to the project site. The suggested dimensions in FIG. 2 and other figures are for reference only. Reactors of substantially any size can be manufactured generally maintaining the proportional dimensions as shown in the figures.

Projects that require a substantially larger treatment volume should use two or more units connected in parallel or in series, depending on the application.

One preferred embodiment of the biological fluidized bed apparatus is illustrated in FIG. 2. This drawing shows part of the reactor base, access ladder and safety railing at the top of the unit. Although the reactor design presented in the drawings was developed for low-density linear polyethylene, it can be fabricated in carbon steel plate, stainless steel, fiberglass, or other suitable materials.

Since the present invention focuses on the design and configuration of an optimized biological fluidized bed apparatus, details regarding start-up, operation and biological and hydraulic design parameters will be apparent to those skilled in the art and will not be given here.

Turning now to FIGS. 1, 2 and 3, the apparatus has an enclosed conical bottom circular tank supported by a steel stand. The tank has an upper cylindrical portion 40 and a lower conical portion 40-1. The conical portion 40-1 of the reactor rests on a conical shape carbon steel plate, to which twelve legs that form the reactor tank metal base 41 are welded. The reactor is filled with water and an inert media biocarrier 27-1, 28-1. Preferred media particle sizes are about 400 to about 600 micrometers (ASTM mesh 30×40) and particle specific gravity of 1.4 as in activated carbon, to 2.2 as in zeolite. Before the particles are colonized by bacterial biofilm, the settled media bed 28-1 reaches a level 28 in the cylindrical portion of the tank 40. A recirculation pump (seen in FIG. 12 at D8) draws water from the upper portion of the tank, past a solids/gas/liquid separator 5, and pumps it back into the bottom of the tank 40-1. The upflow velocity provided by the recirculation flow increases the porosity of the media and fluidizes the bed. The fluidized bed reaches a higher level 27, which is equivalent to an empty bed volume increase of about 20 to about 30 percent with respect to the original settled bed volume. The degree of the volume increase depends on the pump's flow rate.

During start-up of the apparatus, bacterial seed, consumable substrate, macro-nutrients and micro-nutrients are supplied for growing a biofilm. The biofilm grows on each media particle to a thickness ranging between approximately 100 and approximately 200 micrometers. The thickness of the biofilm depends on the initial concentration of the substrate treated in the apparatus, the type of bacteria (i.e., pure acidogenic, methanogenic or denitrifying), and the intensity of the attrition between particles in the bed. The density of the biofilm is only slightly higher than the density of water. As a result, since the inert particle experiences an increase in volume without a significant increase in weight, the specific gravity of the bio-particle as a whole is reduced. This enables the colonized bed to be fluidized with lower upflow velocities than the original bare-particle bed. Additionally, at the same bed porosity, the fluidized empty bed volume increases due to biofilm thickness.

With reference to FIG. 4, the water level 24 inside the apparatus is determined by the location of the overflow weir 34 in the effluent trough 10. In order to start-up the reactor, anaerobic bacteria or denitrifying bacteria are seeded into the unit. Raw waste is fed into the recirculation line 1 (see FIG. 12). The wastewater fed into the line flows out of the reactor over the effluent weir 34, after being treated.

As seen in FIG. 5, from the bottom of the tank 40-1 up to the collar 6 that causes gas bubbles to coalesce, upflow velocity is controlled by the flow rate provided by the recirculation pump D8 and the cross-sectional area at each level of the tank. A ball valve D7 at the discharge of the recirculation pump D8 controls the flow rate through the recirculation system (see FIG. 12). Recirculation flow is maintained constant at a rate sufficient to achieve the desired fluidization of the media (e.g., bed porosity) in the cylindrical portion of the tank.

Recirculating water is suctioned from the return solids accumulation boxes 4 through two suction bulkhead fittings 17, which are piped to the suction port of the recirculation pump. The discharge of the pump is piped to two discharge bulkhead fittings 18. An internal horizontal pipe connects both bulkhead fittings 18 to a PVC cross fitting 33. The cross fitting 33 directs the flow downward through a vertically oriented, down-coming drop recirculation and feed flow discharge pipe 1. The recirculation and feed flow discharge pipe 1 ends in a molded flow distribution fitting 2, that rests at the bottom of the tank 40-1, and includes internal contoured surfaces. In the fitting 2, the direction of the flow changes generally 90 degrees, so that it exits radially at the bottom of the cone. Details of the flow distribution fitting are presented in FIG. 11.

The opening at the perimeter of the flow distribution fitting 2 is such that at the lowest recirculation flow-rate, sufficient radial exit velocity is attained to carry (erode) media particles located at the bottom of the tank, around the fitting. Minimum exit velocity for 30×40 mesh activated carbon media should be about 0.6 m/s. For 30×40 mesh zeolite media the minimum exit velocity should be about 1.2 m/s. The appropriate upflow velocity in the cylindrical portion of the reactor depends on the type and size of media used and the desired overall bed porosity. For activated carbon media, 30×40 mesh, adequate upflow velocity in the cylindrical portion of the reactor is in the order of 8 to 12 meters per hour. For zeolite media, 30×40 mesh, the velocity should be between approximately 15 and 20 meters per hour. In a reactor with the dimensions shown in the figures, the upflow velocity required to fluidize a bed with activated carbon media 30×40 mesh, can be obtained with approximately 30 to 40 liters per second (e.g., 500 to 600 gallons per minute) of recirculation flow rate.

Above the recirculation discharge connection or outflow ports 18, there is no effect of the recirculation flow. Accordingly, between these ports 18 and the effluent overflow weir 34, the upflow velocity is much lower. The upflow velocity in this portion of the apparatus is determined by the feeding flow rate of the waste being treated. Normally, for industrial or animal waste, the ratio of recirculation to feed flow ranges from about 30/1 to 10/1. A quiescent zone with no gas interference is provided in the upper portion of the tank 7, external to the separator 9. In this zone, the upflow velocity decreases gradually as it approaches the effluent overflow weir 34. The reducing velocity causes suspended solids to settle, thus providing effluent clarification. A suspended sludge blanket typically forms in this portion of the tank. This blanket provides further removal of solids by solids contact clarification. In order to control the level of the sludge blanket, a submerged solids overflow weir is provided and illustrated at 36. An electrically actuated PVC ball valve opens on a timer sequence, to withdraw solids reaching above the submerged weir level. These solids are wasted. By keeping the sludge blanket level at a controlled height, sufficient clarification depth is allowed above the sludge-water interface.

As shown in FIG. 12, the biological fluidized bed apparatus works with a closed-loop recirculation system. Untreated wastewater is pumped into the recirculation pump discharge pipe (FIG. 12) where it mixes with partially treated recirculation water withdrawn from two recirculation suction connection ports 17 in the mid-upper portion of the reactor. The mixture enters the reactor 40 and flows downward through the drop pipe 1 and exits radially through the molded flow distribution fitting 2. This drop pipe 1 is submerged in media. By the action of the upflow velocity created by the recirculation flow, the media bed will expand, as indicated in FIG. 2 at 28 and 27.

Above the expanded bed level 27, intense bubbling occurs, as biogas (in the case of methanogenic reactors) or nitrogen gas (in the case of anoxic denitrifying reactors) is generated and released from the bed. The significant external porosity of the fluidized bed (usually 60 to 70 percent) allows gas bubbles to be release rapidly from the bed. The advantage of maintaining such high bed porosities is that coalescence of fine bubbles into larger bubbles inside the bed is minimized. If gas is trapped inside the bed, larger bubbles form by coalescence. Due to their increased buoyancy, larger bubbles emerge through the bed at high velocities and disrupt the bed. Solids that are entrapped in the bed are released by the disturbance, thus increasing suspended solids carry over.

The solid/gas/liquid separator assembly is illustrated throughout FIGS. 6-11. In operation, gas bubbles emerging from the fluidized bed rise through the water. Bubbles rising along the periphery of the bed are deflected to the center of the tank by the sloped bottom of the solids collection trough 3. The solids collection trough 3 continues upward into the sloped lower wall of the separator 5. This conical shaped wall ends in a short cylindrical collar 6. Due to the shape of the lower separator wall 5, the section through which the flow needs to pass is reduced. The reduction in cross-section forces the fine gas bubbles traveling in the flow to coalesce. Larger coalesced bubbles formed are released from the water at high velocity through the collar 6, into the gas space 8 above the water level. Gas is removed from the reactor through a gas release valve 23. The diameter of the separator collar 6 is such that at the recirculation flows required to fluidize the bed, water emerges at about 0.15 to 0.20 m/s. Water spills over the collar 6 and falls into the downflow passage of the separator 37, formed by the lower and upper sloped walls of the separator, i.e. the gas deflector 5 and the recirculation flow deflector 9, respectively. Water flows down the sloped passage and exits at a velocity of approximately 0.015 m/s into the solids trough 3. Once it reaches the trough, it moves toward the two diametrically opposed recirculation suction bulkhead fittings 17, located inside the solids return boxes 4. The bulkhead fittings 17 are connected to the suction of the recirculation pump.

Above the solids trough 3, the flow that continues ascending to the effluent overflow weir 34 is only the wastewater feed flow. That flow is extremely low, being about 1/10 to 1/30 of the recirculation flow, depending on the strength of the wastewater. Suspended solids carried in the full flow descending along the sloped down-flow passage of the solids separator hit the solids trough 3 and most of them remain in the trough 3. There is no sufficient upflow velocity above the level of the trough 3 to carry large solids to the surface of the tank. Ascending flow has to go through the clarification quiescent zone 7 to reach the effluent weir 34. The upflow velocity at the bottom of the clarification quiescent zone is approximately 3 m/h, and it decreases to approximately 1.2 m/h as it approaches the effluent weir. As explained above, the solids that are dragged by this low upflow velocity create a sludge blanket as the upflow velocity in this zone decreases. The sludge blanket enhances suspended solids removal by solids contact clarification.

A solids collection paddle 13 pushes the larger solids that remain in the solids trough 3 into solids collection boxes 4. The solids trough 3 has a total of four collection boxes 4. Two boxes collect solids to be returned into the bed by the recirculation pump, and two other boxes collect solids to be discharged. The four boxes are placed in such a way that most of the solids settling in the solids trough 3 are pushed into the solids return boxes 4. Electrically actuated ball valves, placed in the two solids wastage boxes and operated on a timed sequence, remove the solids accumulated in these boxes. Solids wastage boxes 39 are shown in FIGS. 3 and 6. The solids wastage port 44 is shown in FIGS. 1 and 3. Tip speed of the solids accumulation paddle is 10 feet/min. A motor/gear reducer drive 20 turning at 0.25 RPM provides the mechanical energy. The drive is mounted externally on the cover plate of the tank 35. A driving shaft 21 with a positive drive mechanism locks with a free rotating hub 38, furnished with axial bearings. An arm 22 connects the hub with the paddle 13. The arm rests on two sets of plastic rollers 31. The rollers move along the external surface of the lower cone of the separator 5.

At the surface of the water inside the tank 24, scum and other floatables passing the separator and the clarification quiescent zone, may accumulate and form a crust. An effluent launderer baffle placed along the effluent weir 34 avoids floating solids to exit the reactor over the weir. A surface skimmer 12 rotates along with the solids accumulation paddle. The surface skimmer 12 is driven by a connecting arm 30, which is bolted to the frame of the paddle. This arm also rests on two sets of rollers. These rollers slide on the external surface of the upper cone of the separator 9. The skimmer pushes floating material into a scum box 15. The floating material collected in the scum box 15 is removed by gravity through a bulkhead fitting 16. An electrically actuated valve, operating on a timed sequence, opens and empties the scum box 15.

In order to exit the apparatus, the effluent has to flow under the launderer and over the effluent weir 34 into the effluent trough 10. Two line connection effluent ports with bulkhead fittings 11 are provided. To assure that the effluent trough 3 is emptied completely these bulkhead fittings 11 are placed inside two depressions 19 provided in the solids collection trough 3.

With the biological fluidized bed apparatus, as described above, the disadvantages of existing fluidized bed reactor configurations are greatly overcome. This design provides cleaner effluents and offers a more reliable operation. This compact wastewater treatment apparatus could favorably replace other high-energy consuming treatment technologies.

It will therefore be readily understood by those persons skilled in the art that the present invention is susceptible of a broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

We claim:

1. A biological fluidized bed apparatus for wastewater treatment comprising:
a reactor tank having a generally frusto-conical bottom portion defined by walls formed at a predetermined, generally uniform angle;
an inert media bed disposed within said tank; and
a recirculation pipe having an inlet and an outlet, said recirculation pipe being disposed within said tank with said outlet in fluid communication with said media.

2. A biological fluidized bed apparatus according to claim 1, wherein said predetermined, generally uniform angle is in the range of about 35 to about 80 degrees from a horizontal plane.

3. A biological fluidized bed apparatus according to claim 1, wherein said predetermined, generally uniform angle is in the range of about 45 to about 75 degrees from a horizontal plane.

4. A biological fluidized bed apparatus according to claim 1, wherein said predetermined, generally uniform angle is in the range of about 55 to about 72 degrees from a horizontal plane.

5. A biological fluidized bed apparatus according to claim 1, wherein said predetermined, generally uniform angle is in the range of about 57 to about 70 degrees from a horizontal plane.

6. A biological fluidized bed apparatus according to claim 1, wherein said predetermined, generally uniform angle is about 60 degrees from a horizontal plane.

7. A biological fluidized bed apparatus according to claim 1, wherein said outlet is formed to disperse fluid radially therefrom.

8. A biological fluidized bed apparatus according to claim 7 wherein said recirculation pipe is generally vertically disposed to provide a downwardly flowing stream and said outlet receives said stream for radial dispersion.

9. A biological fluidized bed apparatus according to claim 7 wherein said outlet is formed with smoothly curved inner walls for enhanced flow characteristics.

10. A biological fluidized bed apparatus according to claim 1 and further comprising a solids collection trough disposed in said reactor tank above said media bed, said trough having a solids thickening arrangement and a sloped bottom portion.

11. A biological fluidized bed apparatus according to claim 10 and further comprising a solids/gas/liquid separator assembly disposed above said solids trough and including a generally conical separation assembly having a first generally conical wall and a second generally conical wall forming a down-flow compartment to direct suspended solids into said solids trough.

12. A biological fluidized bed apparatus according to claim 10 and further comprising a sludge blanket clarification assembly disposed within said tank forming a quiescent zone, said sludge blanket clarification assembly including a treated effluent weir, a rotating surface skimmer and a scum collection arrangement.

13. A biological fluidized bed apparatus according to claim 10 and further comprising a recirculation outflow port disposed within said solids trough.

14. A biological fluidized bed apparatus according to claim 13 and further comprising a pump for withdrawing water from said recirculation outflow port, said pump having a discharge pipe connected to said recirculation pipe inlet, forming a assembly for fluidizing said media bed.

15. An apparatus according to claim 13 and further comprising a pump and piping assembly for introducing untreated wastewater into said pump discharge pipe.

16. A biological fluidized bed apparatus for wastewater treatment comprising:
a reactor tank;
an inert media bed disposed within said tank; and
a solids collection trough disposed in said reactor tank above said media bed, said trough having a solids thickening arrangement and a sloped bottom for deflecting gas bubbles toward the center of the tank.

17. A biological fluidized bed apparatus according to claim 16 and further comprising a solids/gas/liquid separator assembly disposed above said solids trough and including a conical separation assembly having a first generally conical wall and a second generally conical wall forming a down-flow compartment to direct suspended solids into said solids trough.

18. A biological fluidized bed apparatus according to claim 17 and further comprising a sludge blanket clarification assembly disposed within said tank forming a quiescent zone, said sludge blanket clarification assembly including a treated effluent weir, a rotating surface skimmer and a scum collection arrangement.

19. A biological fluidized bed apparatus according to claim 16 wherein said reactor tank includes a generally frusto-conical bottom portion defined by walls formed at a predetermined, generally uniform angle.

20. A biological fluidized bed apparatus according to claim 19, wherein said predetermined, generally uniform angle is in the range of about 35 to about 80 degrees from a horizontal plane.

21. A biological fluidized bed apparatus according to claim 19, wherein said predetermined, generally uniform angle is in the range of about 45 to about 75 degrees from a horizontal plane.

22. A biological fluidized bed apparatus according to claim 19, wherein said predetermined, generally uniform angle is in the range of about 55 to about 72 degrees from a horizontal plane.

23. A biological fluidized bed apparatus according to claim 19, wherein said predetermined, generally uniform angle is in the range of about 57 to about 70 degrees from a horizontal plane.

24. A biological fluidized bed apparatus according to claim 19, wherein said predetermined, generally uniform angle is about 60 degrees from a horizontal plane.

25. A biological fluidized bed apparatus according to claim 15 and further comprising a recirculation pipe having an inlet and an outlet, said recirculation pipe being disposed within said tank with said outlet in fluid communication with said media.

26. A biological fluidized bed apparatus according to claim 24, wherein said outlet is formed to disperse fluid radially therefrom.

27. A biological fluidized bed apparatus according to claim 25 wherein said recirculation pipe is generally vertically disposed to provide a downwardly flowing stream and said outlet receives said stream for radial dispersion.

28. A biological fluidized bed apparatus according to claim 15 and further comprising a recirculation outflow port disposed within said solids trough.

29. A biological fluidized bed apparatus according to claim 28 and further comprising a pump for withdrawing water from said recirculation outflow port, said pump having a discharge pipe connected to said recirculation pipe inlet, forming an assembly for fluidizing said media bed.

30. An apparatus according to claim 29 and further comprising a pump and piping assembly for introducing untreated wastewater into said pump discharge pipe.

31. A biological fluidized bed apparatus for wastewater treatment comprising:
a reactor tank having a generally frusto-conical bottom portion defined by walls formed at a generally uniform angle extending about 60 degrees from a horizontal plane;
an inert media bed disposed within said tank;
a solids collection trough disposed in said reactor tank above said media bed, said trough having a solids thickening arrangement and a sloped bottom for deflecting gas bubbles to the center of the tank;
a solids/gas/liquid separator assembly disposed above said solids trough and including a conical separation assembly having a first generally conical wall and a second generally conical wall forming a down-flow compartment to direct suspended solids into said solids trough;
a sludge blanket clarification assembly disposed within said tank forming a quiescent zone, said sludge blanket clarification assembly including a treated effluent weir, a rotating surface skimmer and a scum collection arrangement; and
a generally vertically disposed recirculation pipe having an inlet and an outlet, said outlet being molded and formed to disperse fluid radially therefrom, said recirculation pipe being disposed within said tank with said outlet in fluid communication with said media bed.

32. A biological fluidized bed apparatus according to claim 31 wherein said outlet is formed with smoothly curved inner walls for enhanced flow characteristics.

33. A biological fluidized bed apparatus according to claim 31 and further comprising a recirculation outflow port disposed within said solids trough.

34. A biological fluidized bed apparatus according to claim 33 and further comprising a pump for withdrawing water from said recirculation outflow port, said pump having a discharge pipe connected to said recirculation pipe inlet, forming a assembly for fluidizing said media bed.

35. An apparatus according to claim 34, further comprising a pump and piping assembly for introducing untreated wastewater into said pump discharge pipe.
